(19) United States
(12) Patent Application Publication
(10) Pub. No.: US 2018/0023455 A1
(43) Pub. Date: Jan. 25, 2018

(54) MULTI-STAGE EXHAUST TURBOCHARGER SYSTEM

(71) Applicant: JAGUAR LAND ROVER LIMITED, Whitley, Coventry, Warwickshire (GB)

(72) Inventor: James TURNER, Whitley, Coventry (GB)

(21) Appl. No.: 15/548,510

(22) PCT Filed: Jan. 26, 2016
(86) PCT No.: PCT/EP2016/051547

§ 371 Date: Aug. 3, 2017

(30) Foreign Application Priority Data
Feb. 6, 2015 (GB) 1502009.2

(51) Int. Cl. F02B 29/04; F02B 37/02; F02B 37/013; F02B 37/00; F02B 37/007

(52) U.S. Cl. CPC F02B 29/0412; F02B 37/001; F02B 37/004; F02B 37/007; F02B 37/013; F02B 37/025; F02C 6/12

(57) ABSTRACT

A multi-stage exhaust turbocharger has parallel high pressure stages (30, 40), and a single low pressure stage (60) in series. The low pressure stage (60) has a divided scroll turbine wheel 62 with each scroll fed independently from the respective turbines of the high pressure stage. Valves V1, V2, V3 determine flow paths to the respective turbines to ensure series sequential operation.

### TECHNICAL FIELD

The present disclosure is concerned with a multi-stage exhaust turbocharger system. More particularly, but not exclusively, the present disclosure is concerned with a parallel-series-sequential, regulated, multi-stage turbocharger for use on an internal combustion engine of a vehicle, with an internal combustion engine so equipped, and with a vehicle having such an engine. Aspects of the invention relate to a system, to an engine and to a vehicle.

### BACKGROUND

An exhaust turbocharger allows a small capacity internal combustion engine to produce the same power as a comparatively large capacity naturally aspirated engine, with fuel efficiency.

To further improve performance of internal combustion engines it is known to use turbocharger systems with high and low pressure stages. Such an arrangement can provide good performance over a wide range of exhaust gas flow. One kind of multi-stage turbocharger system comprises two high pressure turbochargers in parallel and one low pressure turbocharger in series with the high pressure turbochargers, with the low pressure turbine downstream of the high pressure turbines.

It is known that the power output of a turbocharger may be increased by increasing the aspect ratio ‘A/R’ of the turbine wheel scroll, where A is the entry area or throat area of a turbine and R is the distance of the centroid of this area A from the turbine shaft axis. However, when the A/R ratio is increased, the response time of the turbocharger may be increased, resulting in ‘turbo-lag’, which is noticed by the vehicle driver as a time delay between a demand for acceleration and a corresponding power increase from the engine.

It would be desirable to increase the power output of a turbocharger system whilst also minimising the response time of the turbocharger system over a range of engine operating speeds.

### SUMMARY OF THE INVENTION

According to the invention there is provided an exhaust turbocharger system, comprising first and second independent turbochargers in parallel and a third independent relatively low pressure turbocharger in series with the first and second turbochargers. Each independent turbocharger may have a turbine wheel with an associated turbine inlet and turbine outlet, and a connected compressor wheel with an associated compressor inlet and compressor outlet, each turbine wheel and connected compressor wheel being rotatable in unison. A plurality of flow control valves may be provided, each control valve comprising a respective valve inlet and valve outlet.

The system may include a first turbocharger having a turbine inlet adapted to be fed directly from an exhaust manifold of an internal combustion engine.

The system may include a second turbocharger having a turbine inlet adapted to be fed from said exhaust manifold via a first flow control valve.

The system may include a second flow control valve having a valve inlet adapted to be fed directly from the exhaust manifold.

The system may include a divided scroll third turbocharger having one turbine scroll in direct communication with the turbine outlet of said first turbocharger and a second turbine scroll in direct communication with the turbine outlet of said second turbocharger.

The system may include a third flow control valve having a valve inlet from the valve outlet of the second flow control valve.

The valve outlet of the third flow control valve may be configured for connection to an exhaust downstream of the turbocharger system.

The turbine outlet of the first turbocharger may be connected to the valve inlet of the third flow control valve.

The turbine outlet of said second turbocharger may be connected to the valve inlet of the third flow control valve.

A turbocharger system according to embodiments of the invention can provide for effective boosting of the inlet air charge throughout the normal operating range of an internal combustion engine, with reduced turbo lag, and reduced risk of retaining combustion products within the combustion chambers of the engine.

The divided scroll third turbocharger may be of any known kind, and for example the scrolls may be arranged axially (side by side) or radially so as to be able to provide a separate and a combined effect on the turbine wheel.

In an embodiment a common housing is provided for some or all of the independent turbochargers. This arrangement may reduce flow path connections, and may also reduce overall turbocharger mass to the intent that cold start light-off of the usual exhaust catalyst is not unduly delayed. In an embodiment one or more of the control valves may be provided in such a common housing—that is to say the fixed element(s) of a respective valve may be defined by the housing, and the moving element(s) assembled thereto.

Any control valve suitable for use in a turbocharger may be used, for example a spring-closed poppet valve having a respective actuator, for example an electric or pneumatic actuator, for operation thereof under the control of a controller. The controller may typically comprise an electronic control unit having a look-up table, map or algorithm responsive to speed and/or load of the engine to control opening and closing of said control valves in the desired sequence.

In an embodiment the compressor inlet of said first turbocharger and the compressor inlet of said second turbocharger are connected to the compressor outlet of said third turbocharger.

In an embodiment a fourth flow control valve has a valve inlet from the compressor outlet of said second turbocharger.

In an embodiment a fifth flow control valve has a valve inlet from the compressor outlet of said third turbocharger, and a valve outlet to the valve inlet of the fourth flow control valve.

In an embodiment the valve outlet of the fourth flow control valve is adapted to feed an inlet manifold of an internal combustion engine, and the compressor outlet of said first turbocharger is adapted to feed said inlet manifold.

Aspects of the invention are defined in the accompanying claims and also relate to an internal combustion engine of a motor vehicle, which may be a four stroke, reciprocating piston, gasoline engine, and to a wheeled motor vehicle so equipped.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawing, in which:

FIG. 1 shows schematically a turbocharger system according to a first embodiment of the invention.

### DETAILED DESCRIPTION OF AN EMBODIMENT OF THE INVENTION

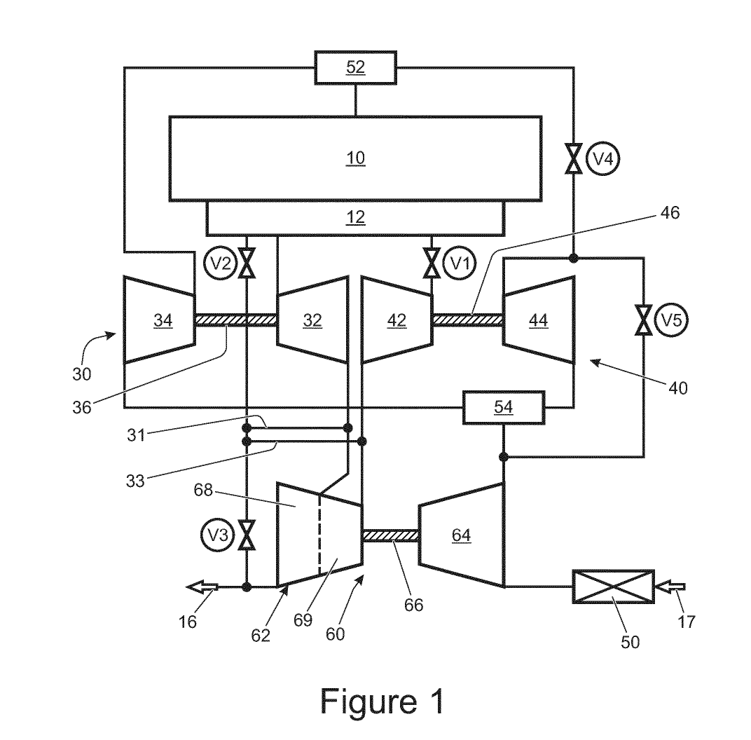

FIG. 1 shows schematically an arrangement of independent turbochargers of a turbocharger system according to an embodiment of the invention. The independent turbochargers may be incorporated within a common housing or comprise a substantially unitary assembly.

An internal combustion engine 10 has an exhaust manifold 12. A turbocharger system comprises first relatively high pressure turbocharger 30, a second relatively high pressure turbocharger 40, a relatively low pressure divided scroll turbocharger 60, flow control valves V1, V2, V3, V4, and, V5, an air inlet 17 with air filter 50, charge air coolers 52, 54, and an outlet 16 to a vehicle exhaust.

The exhaust manifold 12 collects in conventional manner the exhaust gases from the internal combustion engine 10, which are ducted to the first high pressure turbocharger 30, comprising a turbine wheel 32 and a compressor wheel 34 coupled for rotation on a common shaft 36. The turbine wheel 32 has an inlet in direct fluid communication with the exhaust manifold 12.

The second high pressure turbocharger 40 comprises a turbine wheel 42 and a compressor wheel 44 coupled for rotation on a common shaft 46. A first control valve V1 comprises an inlet in direct fluid communication with the exhaust manifold 12 and an outlet which is in connected to the inlet for the turbine wheel 42.

A second flow control valve V2 comprises an inlet which is in direct fluid communication with the exhaust manifold 12 and an outlet to a location downstream of the turbines of the turbochargers 30, 40, as will be explained below.

A third flow control valve V3 comprises an inlet which is connected to an outlet of flow control valve V2 and an outlet which is open to an exhaust system 16 of conventional kind. Fluid branches 31, 33 also connect the outlet of the second flow control valve to the inlet of a low pressure turbocharger 60, as illustrated.

The low pressure turbocharger 60 comprises a turbine 62 and a compressor 64, coupled for rotation on a common shaft 66. The turbine 62 has a first scroll 68 and a second scroll 69, arranged either side by side axially on the shaft 66, or circumferentially (meridionally). The scrolls 68, 69 have a common turbine outlet in communication with the outlet 16 to the exhaust system.

The first high pressure turbine wheel 32, has an outlet which is in fluid communication with the first scroll 68 of the low pressure turbine 62, and the second high pressure turbine wheel 42 is in fluid communication with the second scroll 69 of the low pressure turbine 62.

As noted above, the fluid branch 31 which connects the outlet of the turbine wheel 32 with the first scroll 68 has a gas flow path to the outlet of flow control valve V2. Similarly, the fluid branch 33 which connects the outlet of high pressure turbine wheel 42 with the second scroll 69 also has a gas flow path to the outlet of flow control valve V2. Whilst two separate paths are illustrated, a single path may suffice for at least the final part of the respective fluid ducts.

An air filter 50 comprises an air inlet 17, and an outlet in fluid communication with the inlet of the low pressure compressor 64, which is conventional.

The low pressure compressor 64 has an outlet which is connected via a fluid duct to a charge air cooler (intercooler) 54. The fluid connection to the charge air cooler may be by a conventional branched flexible hose, and/or by internal passages of a turbocharger housing.

The charge air cooler 54 has two outlets; the first outlet is connected to an inlet of the first high pressure compressor wheel 34 and the second outlet is connected to an inlet of the second high pressure compressor wheel 44.

A second charge air cooler 52 comprises two inlets and an outlet. The outlet is adapted to feed compressed air to the internal combustion engine 10. One of the inlets of the charge air cooler 52 is connected to the outlet of high pressure compressor wheel 34. The remaining inlet of charge air cooler 52 is connected to the outlet of a fourth flow control valve V4. The inlet paths could alternatively be combined upstream of the charge air cooler 52. Again the fluid path may be via a flexible hose and/or internal passage of the turbocharger housing.

Control valve V4 has an inlet which is connected to the outlet of high pressure compressor wheel 44. A fifth control valve V5 has one port which is connected to the outlet of low pressure compressor wheel 64, and another port which is connected downstream of the outlet of the high pressure turbine wheel 44, as illustrated. The fifth control valve V5 provides a bypass for the compressor of the second high pressure turbocharger 40.

In use, the turbocharger has multiple phases of operation which are active according to engine speed, and gas flow in the exhaust manifold. The control valves V1-V5 are sequenced for operation at different flow rates of exhaust gas, as follows.

Phase 1

At low gas flows, exhaust gas exiting the exhaust manifold 12 is directed to a relatively small diameter turbine wheel 32. The small diameter turbine wheel is selected to spool up at low flow rates so as to provide charge compression via the compressor wheel 34 at low engine speeds. The compressor wheel 34 is driven via the common shaft 36 to compress the inlet gas which has passed through a low pressure charge air cooler 54. The low pressure charge air cooler 54 is provided with gas from the compressor wheel 64 of the divided turbocharger 60. The compressed gas exits compressor wheel 34 at a higher pressure and is directed via a high pressure charge air cooler 52 to the air intake manifold (not shown) of the engine 10.

The first turbine scroll 68 of the twin scroll turbine of turbocharger 60, receives gas via passage from the outlet of turbine wheel 32, which in turn drives the low pressure compressor wheel 64.

During the first phase turbochargers 60 and 30, provide boost, and thus turbocharging of the internal combustion engine 10 is effected at low rates of exhaust gas flow. Flow control valves V1-V4 are shut in phase 1. Control valve V5 is open, but the path to the inlet manifold is closed by control valve V4; the output from a spinning compressor wheel 44 is thereby allowed to recirculate, to make it ready for operation as the flow of exhaust gas increases. If necessary a further control valve may be provided to prevent flow from the outlet of turbine wheel 32 to the second turbine scroll 69 via the fluid branches 31, 33.

Phase 2

As the engine speed increases so does the mass flow rate of exhaust gas. At intermediate gas flow rates at the low/medium transition, the first turbine wheel 32 will approach maximum flow rate, and accordingly flow control valve V1 is opened progressively in a controlled manner to supply exhaust gas to the second high pressure turbocharger 40 and to rotate the turbine wheel 42, thus causing consequential rotation of the second compressor wheel 44.

At a medium flow rate, in addition to the gas flow through turbocharger 30, flow control valve V1 is fully open such that gas can flow from the exhaust manifold 12 to turbine wheel 42 of the second high pressure turbocharger 40. The second turbine scroll 69 of the twin scroll, low pressure turbocharger 60, receives exhaust gas from the outlet of turbine wheel 42. The second compressor wheel 44 is accordingly driven via the common shaft 46 to compress the inlet gas which has passed through the low pressure charge air cooler 54. Valve V4 is opened and compressed gas is provided to the high pressure charge air cooler 52, and thence to the inlet manifold; valve V5 is closed to obviate recirculation.

Phase 3

At intermediate gas flow rates at the medium/high transition, the second stage may approach its design capacity and accordingly flow control valve V2 is opened so as to allow excess mass flow to bypass the high pressure turbine wheels 32, 42. Thus the high pressure turbines are not allowed to choke flow and increase back pressure in the exhaust manifold. In this phase each high pressure turbine, and hence high pressure compressor, is fully effective.

At high gas flow rates, flow control valve V2 is fully open so that the excess mass flow rate, which surpasses the capacity of turbine wheels 32 and 42, can bypass turbine wheels 32 and 42. Exhaust gas thus flows into passages 31, 33 and supplements the outflow from turbine wheels 32, 42, to fully utilise the available capacity of the low pressure turbocharger 60.

Phase 4

As flow rates from the manifold 12 further increase to a maximum, flow control valve V3 can be opened progressively to prevent back pressure from the low pressure turbine 62; valve V3, like valve V2 operates as a wastegate as the flow capacity of the respective turbine wheels 32, 42 and 62 is reached. Such flow rates are typically reached at or very close to maximum engine rpm.

Mode of Operation

A high pressure turbine can provide boost effectively at low mass flow rates and a low pressure turbine can provide boost at high mass flow rates.

The divided low pressure turbocharger 60 receives exhaust gas from the parallel high pressure turbochargers 30, 40. Each high pressure turbocharger provides gas to an independent scroll 68, 69. At low gas flow rates i.e. low engine speeds, one of the high pressure turbocharges is disabled by closure of valve V1.

At low gas flow rates there is an insufficient mass flow rate to drive both high pressure turbines or one low pressure turbine. By disabling one high pressure turbine there is sufficient mass flow to drive the working high pressure turbine effectively; however there is still insufficient mass flow rate to drive a single scroll low pressure turbine with the large throat area that is required to deal with high mass flow rates.

By dividing the effective throat of the low pressure turbine into two distinct scrolls, the low pressure turbine can spool up quickly at lower flow rates due to the reduced A/R ratio. At increased flow rates, i.e when both high pressure turbines are functioning, there is sufficient mass flow to drive a large area and thus the effective throat area of the low pressure turbine is substantially increased. At very high mass flow rates the high pressure turbines can be bypassed and both scrolls of the low pressure turbines receive gas from the exhaust manifold via the fluid branches 31, 32. This is a form of regulated multi-stage operation for the turbocharger system of this embodiment.

On the compressor side, the progressive introduction of the turbine wheels 32, 42, and the twin scrolls of the turbine wheel 62 provide for a progressive boosting of inlet air flow as each compressor wheels 34, 44, 64 becomes effective. Operation of control valves V1, V2 and V3 is according to an algorithm or look-up table of an electronic processor, to the intent that the output of the turbocharger system is efficient over the full range of exhaust gas flow rate. The arrangement provides for minimized turbo lag since the respective turbines and turbine scrolls each have a relatively narrow but cumulative operating range. The arrangement also provides reduced pumping work for the engine and reduced trapping of combustion residuals in the engine cylinders, which are known to be important factors in the operation of spark-ignition engines.

1-22. (canceled)

1. An exhaust turbocharger system, comprising:
a first turbocharger having a turbine inlet adapted to be fed directly from an exhaust manifold of an internal combustion engine;
a first flow control valve;
a second turbocharger having a turbine inlet adapted to be fed from said exhaust manifold via the first flow control valve;
a second flow control valve having a valve inlet adapted to be fed directly from the exhaust manifold;
a divided scroll third turbocharger having one turbine scroll in direct communication with a turbine outlet of said first turbocharger and a second turbine scroll in direct communication with a turbine outlet of said second turbocharger;
a third flow control valve having a valve inlet adapted to be fed from a valve outlet of the second flow control valve;
a valve outlet of the third flow control valve being for connection to an exhaust;
a turbine outlet of the first turbocharger being connected to the valve inlet of the third flow control valve; and
a turbine outlet of said second turbocharger being connected to the valve inlet of the third flow control valve.

24. The turbocharger system according to claim 23, wherein
the divided scroll third turbocharger comprises a turbine wheel with two scrolls only;
said two scrolls are arranged side by side on an axis of rotation thereof, or are arranged radially with respect to each other and a common axis of rotation thereof.

25. The turbocharger system according to claim 23, wherein the first and second independent turbochargers have respective turbine wheels rotatable in a common housing.

26. The turbocharger system of claim 25, wherein a turbine wheel of said third turbocharger is rotatable in said common housing.

27. The turbocharger system of claim 26, wherein through passages for exhaust gas are defined by said common housing.

28. The turbocharger system of claim 25, wherein one or more of said control valves is contained in said common housing.

29. The turbocharger system of claim 25, comprising said exhaust manifold.

30. The turbocharger system of claim 25, wherein said common housing comprises said exhaust manifold.

31. A turbocharger according to claim 23, wherein:
a compressor inlet of said first turbocharger and a compressor inlet of said second turbocharger are connected to a compressor outlet of said third turbocharger;
a fourth flow control valve has a valve inlet adapted to be fed from a compressor outlet of said second turbocharger;
a fifth flow control valve has a valve inlet adapted to be fed from the compressor outlet of said third turbocharger, and a valve outlet to the valve inlet of the fourth flow control valve;
a valve outlet of the fourth flow control valve is adapted to feed an inlet manifold of the internal combustion engine, and a compressor outlet of said first turbocharger is adapted to feed said inlet manifold.

32. The turbocharger system of claim 31, comprising an intermediate charge air cooler downstream of a compressor wheel of said third turbocharger and upstream of the respective compressor wheels of said first and second turbochargers.

33. The turbocharger system of claim 32, wherein the valve inlet of said fifth flow control valve is upstream of said intermediate charge air cooler.

34. The turbocharger system of claim 33, wherein said intermediate charge air cooler has a separate outlet to respective compressor inlets of said first and second turbochargers.

35. The turbocharger system of claim 31, comprising a terminal charge air cooler upstream of said inlet manifold.

36. The turbocharger system of claim 35, wherein said terminal charge air cooler has an air inlet adapted to be fed from the compressor outlet of said first turbocharger, and an air inlet adapted to be fed from the valve outlet of said fourth control valve.

37. A turbocharger according to claim 31, wherein through passages for inlet gas are defined by a common housing of the turbochargers.

38. The turbocharger system of claim 23, comprising a controller for determining sequential opening of said first and second control valves to permit sequential operation of respective turbines of said first, second and third turbochargers.

39. An internal combustion engine comprising a turbocharger system and controller according to claim 38.

40. The turbocharger system of claim 23, comprising a controller for determining opening and closing of said control valves to permit series operation of said first, second and third turbochargers.

41. An internal combustion engine comprising a turbocharger system according to claim 23.

42. A vehicle comprising an internal combustion engine according to claim 41.
